(19) United States
(12) Patent Application Publication
(10) Pub. No.: US 2017/0130541 A1
(43) Pub. Date: May 11, 2017

(54) SERIES AND PARALLEL SEPARATION DEVICE

(71) Applicant: M-I L.L.C., Houston, TX (US)

(72) Inventor: Darrell Caldwell, Walton, KY (US)

(21) Appl. No.: 15/349,431

(22) Filed: Nov. 11, 2016

Related U.S. Application Data
(60) Provisional application No. 62/254,002, filed on Nov. 11, 2015.

(51) Int. Cl. E21B 21/06; B01D 33/37; B01D 33/41; B01D 35/20; B01D 33/03

(52) U.S. Cl. CPC E21B 21/065; B01D 35/20; B01D 33/0376; B01D 33/41; B01D 33/37

(57) ABSTRACT

An apparatus and method directed to a vibratory separator configured to interchangeably operate in parallel distribution mode and combination series distribution mode for separating solid material suspended in incoming fluid is provided. The vibratory separator includes a top screening deck, a first intermediate screening deck, a second intermediate screening deck, and a bottom screening deck. The vibratory separator may be configured to distribute the incoming fluid in either parallel distribution flow or combination series distribution flow, whereby a bottom screen assembly disposed on the bottom screening deck is included when the vibratory separator is operated in the combination series distribution flow, and wherein the bottom screen assembly is excluded from the bottom screening deck when the vibratory separator is operated in the parallel distribution flow.

### CROSS REFERENCE TO RELATED APPLICATIONS

This application claims the benefit of U.S. Provisional Application No. 62/254,002 filed on Nov. 11, 2015, incorporated by reference herein in its entirety.

### BACKGROUND

Vibratory separators are used to separate solid particulates of different sizes and/or to separate solid particulate from fluids. Vibratory separators may be used in various industries such as the oil and gas industry, food industry, cleaning industry, waste water treatment, and others. A vibratory separator is a vibrating sieve-like table upon which, in some embodiments, a solids-laden fluid is deposited and through which clean fluid emerges. The vibratory separator may be a table with a generally perforated filter screen bottom. In one type of vibratory separator, the vibratory separator may include one or more screens for filtering fluid that includes solid particles suspended in the fluid. Fluid is deposited at the feed end of the vibratory separator. As the fluid travels down the length of the vibrating table, the fluid falls through the perforations to a reservoir below, leaving the solid particulate material behind. The vibrating action of the vibratory separator table conveys solid particles left behind to a discharge end of the separator table.

Oil and gas applications use drill bits to drill into rock formations located beneath the earth's surface. Drilling rigs and various other equipment may be located over a well bore to access and extract any oil and gas located in the formation. High power drill bits may be attached to the distal end of casings and other tubular equipment necessary in forming the well bore. These drill bits use drilling fluid (usually liquid), which is also commonly referred to as “drilling mud” or simply “mud”. Drilling mud may be mixed at the surface of a borehole and pumped downhole via one or more pumps at high pressure through a bore of a drill string. A drill string may be a column, or string, of drill pipe, oftentimes hoisted by a drilling rig, that transmits drilling fluid and torque to the drill bit. The drilling mud may be circulated through the drill string and the plurality of attached pieces of drilling pipe to the drill bit located in the wellbore. Once the mud reaches the drill bit, it may exit through various nozzles and ports located on the drill bit at the bottom of the well bore where the mud lubricates and cools the drill bit.

In addition to lubricating the drill bit during the drilling of a wellbore, drilling mud may be used to carry crushed or cut rock (“cuttings”) up to a surface of a well bore. As a drill bit pulverizes or scrapes the rock formation at the bottom of the borehole, small pieces of solid material that include the rock cuttings are left behind. The cuttings must then be removed to clear the well bore, which is accomplished using the drilling mud. High pressure forces acting on the drilling mud via the one or more pumps located at the surface may make the drilling mud flowing through the drill string and out the nozzles of the drill bit continue to flow back to the surface of the well bore. As the drilling mud returns to the surface, the drilling mud carries the cuttings up the annular space (“annulus”) that exists between the drill string and the sides of the well bore, up through the well bore, where it emerges back at the surface.

As part of drilling practices, a vibratory separator may be located at the surface near the drilling rig and well bore, and is used to filter out the cuttings and other debris or solid particles carried out from the well bore by the used drilling mud. After being distributed to the vibratory separator, the filtered drilling mud may be directed to one or more mud pits for further treatment and/or returned to circulate through the well bore.

### BRIEF DESCRIPTION OF DRAWINGS

FIG. 1 shows a sectional side view of a vibratory separator according to embodiments of the present disclosure.

FIG. 2 is a diagram of a vibratory separator configured to operate in parallel distribution flow according to embodiments of the present disclosure.

FIG. 3 is a diagram of a vibratory separator configured to operate in combination series distribution flow mode according to embodiments of the present disclosure.

FIG. 4 is a flowchart of a process for distributing fluid in a vibratory separator according to embodiments of the present disclosure.

### DETAILED DESCRIPTION

Embodiments of the present disclosure will be described below with reference to the figures. In one aspect, embodiments disclosed herein relate to methods and apparatuses for distributing fluid in a vibratory separator apparatus configured to operate in either parallel or combination series fluid distribution mode. Vibratory separators are also known as “shale shakers” and/or “shakers”.

As used herein, drilling fluid may include without limitation, all drilling fluids known to one of ordinary skill in the art, including without limitation, water based, oil based, and/or synthetic based fluid. Drilling fluid, also be referred to as “drilling mud” or “mud” herein, and may be a special composition including, without limitation, clays, fluids, additives, and/or chemicals.

Different embodiments disclosed herein may include vibratory separators that provide an effective solids control solution to various industries, including the oil and gas industry, where space is oftentimes limited near a well bore and drilling site. It is recognized by the different embodiments described herein that drilling fluid is a valuable and useful part of the drilling process. The drilling fluid is often times mixed and altered to best match the corresponding well bore conditions and geological characteristics of the formation where the well bore is located.

According to embodiments of the present disclosure, a vibratory separator may be selectively configured, i.e. interchangeably, operated in parallel distribution flow or combination series distribution flow, depending on, for example, the processing conditions for filtering fluids, such as filtering size and flow rate. As used herein, parallel distribution flow refers to a type of fluid flow through a multi-deck vibratory separator in which a fluid is directed to two or more decks of the vibratory separator such that the fluid is processed (or filtered) on the two or more decks simultaneously. For example, a fluid may enter the vibratory separator and the flow of fluid may be split between two decks of the vibratory separator. In other embodiments, a fluid may enter the vibratory separator, pass through a first screen, for example of a scalping deck, and the effluent flow may then be split between two decks of the vibratory separator. As used herein, combination series distribution flow refers to a type of fluid flow through a multi-deck vibratory separator in which a fluid is directed through parallel distribution flow and series distribution flow. Series distribution flow refers to fluid flow through a multi-deck separator where the fluid is directed to multiple decks of the vibratory separator sequentially. Thus, in combination series distribution mode, a portion of the vibratory separator may be configured to direct fluid to two or more decks simultaneously (for parallel separation), and another portion of the vibratory separator may be configured to direct fluid sequentially to one or more decks of the vibratory separator (for series separation). For example, in combination series distribution mode, fluid may first flow in parallel distribution mode, simultaneously through two or more decks in a vibratory separator (where fluid goes through parallel separation), and then the fluid may flow in series distribution mode, sequentially directed through two or more decks in the vibratory separator (where the fluid goes through series separation). Embodiments described herein may offer the flexibility to switch between modes on a single vibratory separator, thereby offering the unique benefits and advantages of each mode on the same vibratory separator.

As used herein, the term “coupled” or “coupled to” may indicate establishing either a direct or indirect connection, and is not limited to either unless expressly referenced as such. Further, while reference is made herein to a drilling fluid, one of ordinary skill in the art will appreciate that embodiments disclosed herein may also apply to other fluids in other industries for the separation of solids from liquids. Wherever possible, like or identical reference numerals are used in the figures to identify common or the same elements. The figures are not necessarily to scale and certain features and certain views of the figures may be shown exaggerated in scale for purposes of clarification.

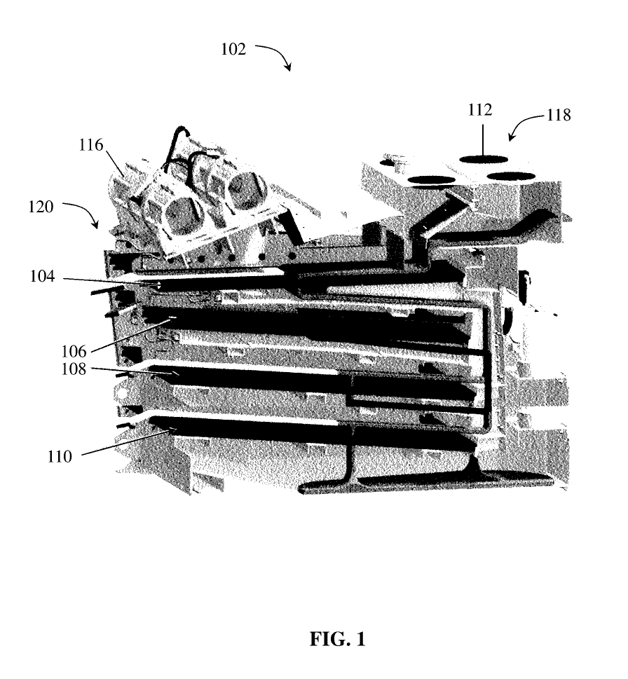

FIG. 1 shows an elevation side view of a vibratory separator according to embodiments described herein. FIG. 1 is a simplified elevation view and one of ordinary skill will understand that additional components may be used to operate vibratory separator 102 shown in FIG. 1.

Vibratory separator 102 may be utilized to separate a liquid mixture of used drilling fluid and solids that are suspended or contained in the liquid mixture. Before used drilling fluid may be reused again in a drilling string, the used drilling fluid is filtered so as to remove any unwanted solid particles and cuttings that contaminate the drilling fluid. In one or more embodiments, vibratory separator 102 is a multi-deck vibratory separator, i.e., shaker, and includes a plurality of screening decks. Vibratory separator 102, as shown in FIG. 1, includes four screening decks, including top screening deck 104, first intermediate screening deck 106, second intermediate screening deck 108, and bottom screening deck 110. Each screening deck is positioned beneath a previous screening deck in a descending vertical direction, except for top screening deck 104, which is the topmost screening deck located in vibratory separator 102. In one or more embodiments, top screening deck 104 may be a scalping deck.

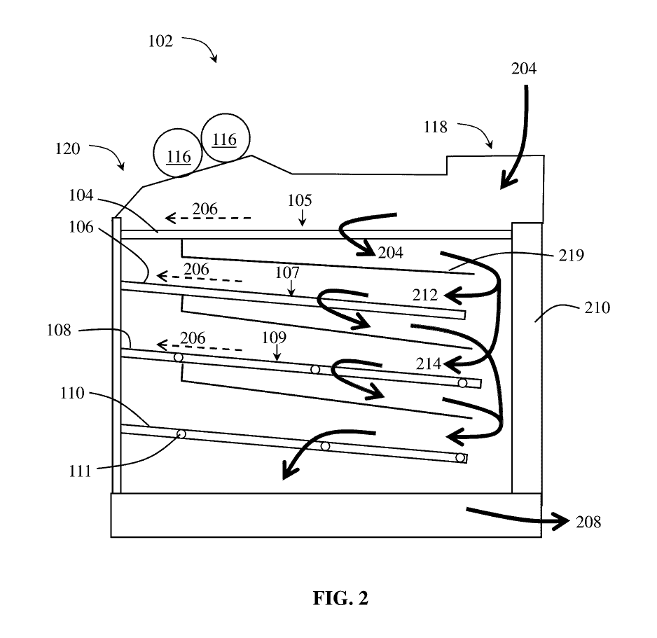

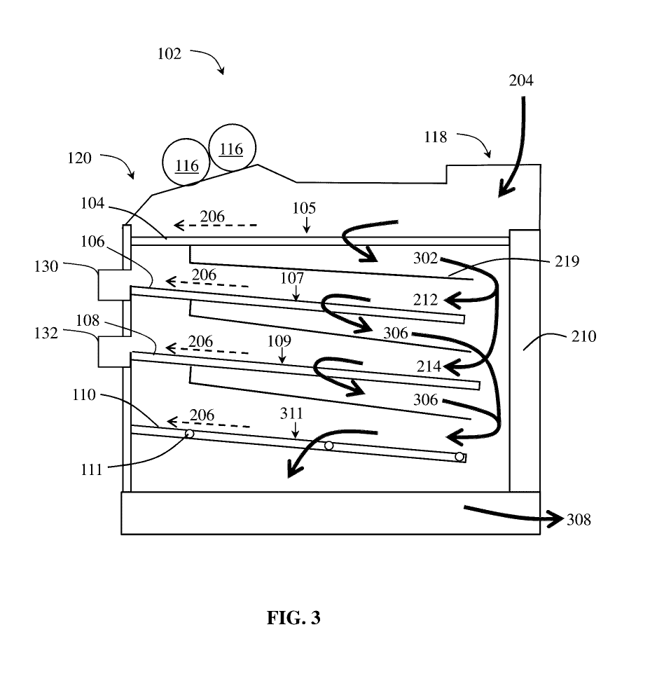

In one or more embodiments, a screen (not shown in FIG. 1) may be provided on each of the screening decks in order to filter out solids of various sizes from the used drilling fluid according to the size of the respective mesh. In some embodiments, the screen may be part of screen assemblies 105, 107, 109, and 111 (shown in FIGS. 2 and 3).

In some vibratory separators, such as vibratory separator 102, the feed end of one or more screening decks in the separator may be relatively closer to the ground than the discharge end. In such vibratory separators, the angle of inclination may require the movement of particulates in a generally upward direction. In some vibratory separators, one or more screening decks may not be angled, where the vibrating action of the separator alone may enable particle/fluid separation. Other vibratory separators may include other screening deck inclination and/or design variations. The vibratory separator 102 in FIGS. 2 and 3 shows that the feed end 118 of a top screening deck 104 (which may also be referred to as a scalping deck) of the vibratory separator 102 is initially at substantially the same level as discharge end 120 of the top screening deck 104, and then with each subsequent screening deck, the screening deck is tilted or angled in a generally upward direction from the feed end 118 to the discharge end 120 of the screening deck.

In one or more embodiments, vibratory separator 102 may optionally include a deck adjustment mechanism for adjusting the angle of one or more screening decks located on vibratory separator 102. In such embodiments, the top screening deck 104, the first intermediate screening deck 106, the second intermediate screening deck 108, and the bottom screening deck 110 may be initially disposed at an angle with either the discharge end being located higher or lower than the feed end of each screening deck. An angle adjustment mechanism (not shown) may be disposed on vibratory separator 102 for adjusting the initial angle settings of one or more screening decks. In some embodiments, only certain screening decks may be adjustable with respect to their screen tilt angle. Further, in other embodiments, the screening decks may all be fixed so that none of the screening decks may be adjustable with respect to their angle. In one or more embodiments, one or more screening decks do not have an angle of inclination, but are rather fixed at a horizontal level.

Vibratory separator 102 includes one or more motors 116 for imparting vibratory motion while separating solid material from the used drilling fluid when vibrator separator 102 is operational in one or more modes. Initially, incoming fluid, i.e., the liquid mixture of used drilling fluid containing various solid material and particles that has been brought up to the well bore surface, may be directed to the feed end 118 of the vibratory separator 102. Vibratory separator may include a plurality of feed ducts, such as feed duct 112, which may be disposed on a top surface of the vibratory separator 102. Vibratory separator 102 further includes discharge end 120, which is the end of vibratory separator 102 where solid particles are directed because of the motion imparted by the one or more motors 116 and any other additional motion devices that may be included along with vibratory separator 102. Those of ordinary skill will recognize that the present disclosure is not limited to any particular form of mounting or attachment of the screen assemblies used in conjunction with the vibratory separator 102.

In one or more embodiments, a receptacle or container (not shown) may be disposed adjacent to the discharge end 120 of vibratory separator 102 for receiving and holding any cuttings and/or other solids to be collected after the solids are separated from the incoming fluid. In one or more embodiments, such a receptacle or container may be disposed adjacent to a lower end of vibratory separator 102, so as to catch any solids that are discharged directly off of any one of the four screening decks as result of the motion of the vibratory separator 102 when activated. Additionally, in one or more embodiments, a skid or sump (not shown) may be provided below the vibratory separator 102 for collecting the drilling fluid which flows out an exit of the vibratory separator, e.g. 208 in FIGS. 2 and 308 in FIG. 3, of the vibratory separator.

FIG. 2 shows a diagram of a vibratory separator in parallel distribution mode according to embodiments described herein. The vibratory separator 102 includes four screening decks, i.e. 104, 106, 108, and 110. Screen assemblies 105, 107 and 109 are disposed on screening decks 104, 106 and 108, respectively. Screen assemblies may be fastened to or disposed on screening decks with one or more interlocking features. For example, as shown fasteners 111 may be used to couple screen assemblies to one or more screen decks. A fluid may be fed into a feed end 118 of the vibratory separator, where the incoming fluid is shown as having a direction of flow 204. The solids separated by screening decks 104, 106, 108 from the incoming fluid due to the motion of the vibratory separator 102 may move towards the discharge end 120 in a discharge direction 206. After having passed through the screen assemblies included in vibratory separator 102 shown in FIG. 2, the outgoing fluid exits 208 the vibratory separator 102.

In FIG. 2, vibratory separator 102 may include at least one screen assembly on each screening deck 106, 108 with the exception of the bottom screening deck 110 in which the screen assembly is optional. Prior to activating vibratory separator 102, an associated operator of the vibratory separator 102 may make a determination whether it is preferable to operate the vibratory separator 102 in parallel or combination series mode. Each mode may offer certain advantages over others. For example, vibratory separators 102 tend to be used on site for filtering out solids and recovering drilling fluid. At times, vibratory separators, such as vibratory separator 102, may be operated in parallel mode or at capacity where high volumes of drilling fluid are directed to the vibratory separator. Accordingly, screen life, i.e., a period of time that a screen disposed on a screening deck is useful in separating the solids it is anticipated to separate, is a consideration that affects screen, vibratory separator, and flow distribution selection. By switching the operation from combination series to parallel distribution flow, as disclosed herein, the screen life may be prolonged.

Further, depending on the composition of the incoming drilling fluid, it may be useful to operate the vibratory separator in a particular mode with screens selected so as to recover certain desirable additives, such as lost circulation material (LCM) and well bore strengthening material (WSM), which is further discussed below.

When a determination has been made to operate vibratory separator 102 in parallel mode, bottom screening deck 110 does not include a bottom screen assembly. The other three screening decks 104, 106, 108 above the bottom screening deck 110 are each provided with a screen assembly, i.e., top screen assembly 105, first intermediate screen assembly 107, and second intermediate screen assembly 109, respectively. Various types of screen assemblies, attachment mechanisms, or mesh screen arrangements known in the art may be used for the disclosed screen assemblies.

In one or more embodiments, top screening deck 104 may act as a “scalping deck”, which means that the top screening deck has a mesh size suitable for removing large drill cuttings and large solids from the incoming fluid. The first intermediate screening deck 106 and the second intermediate screening deck 108 may act as primary screening decks for screening out the remaining solids suspended in the incoming fluid that remain after passing through the top screen assembly 105. In some embodiments, the top screening deck may have a screening assembly with the largest mesh size (relative to the other screening assemblies in the vibratory separator), and the intermediate screening decks may have screening assemblies with relatively smaller mesh size, where the mesh size of the intermediate screening assemblies may be the same or different. For example, in some embodiments, a top screening assembly may have a first size mesh, a first intermediate screening assembly may have a second size mesh (smaller than the first size, i.e., smaller openings formed in the mesh), and a second intermediate screening assembly may have a third size mesh (smaller than the second size). In such embodiments, the majority of solids may be removed by the top two screening decks (the top screening deck and the first intermediate screening deck), while the second intermediate screen assembly may have a mesh size suitable for removing fine solids. Fine solids in the drilling fluid may negatively affect the physical properties of the drilling fluid if the drilling fluid is reused and pumped again downhole. Thus, removal of at least some of the fine solids may reduce negative effects on drilling, such as incorrect fluid weight and damaged drilling components.

FIG. 2 shows arrows for orientation purposes of various elements and components of the vibrator separator while operating in parallel distribution mode. The direction of flow 204 shown above a top surface of top screening deck 104 indicates the direction of flow of the incoming fluid, which may be fed through one or more feed ducts of a feeder located above a top screening deck (e.g. feed ducts 112 in FIG. 1). Those of ordinary skill will appreciate that any incoming fluid may be fed in at different locations along vibratory separator 102 other than the entrance point shown, for example purposes, in FIG. 2.

After passing through an initial separation through top screen assembly 105, the fluid may flow 204 via a first flow back pan 219 towards the feed end 118 of the vibratory separator 102. The underflow (via flow path 212 and 214) may then flow to first intermediate screening deck 106 and second intermediate screening deck 108 respectively. Underflow may be described as a remaining percentage or amount of the mixture of used drilling fluid and contained solid material after having passed through any one of the plurality of screening decks disposed on the vibratory separator. Underflow is also referred to as “effluent”. Thus, in FIG. 2, the illustrated arrow associated with 212 provides the direction of flow of the underflow that flows from top screen assembly 105 to a top surface of first intermediate screen assembly 107. Additionally, the illustrated arrow associated with 214 provides the direction of flow of the underflow directed from top screen assembly 105 to a top surface of second intermediate screen assembly 109.

In one or more embodiments, and as shown in FIG. 2, parallel distribution flow is achieved by directing even or substantially even amounts of underflow to a first intermediate screen assembly 107 and a second intermediate screen assembly 109 at the same time, i.e., by splitting the underflow to two different screen assemblies on two different decks. Those of ordinary skill will appreciate that in some embodiments, less than or more than even amounts may distributed. Those of ordinary skill will also appreciate that in some embodiments the underflow may be distributed to a first intermediate and second intermediate screen assembly at different time intervals.

In some embodiments, more than two intermediate screening decks (each intermediate screening deck having an intermediate screen assembly) may be included between a top screening deck and a bottom screening deck, where underflow from the top screening deck may be directed to each of the intermediate screening decks in substantially even amounts concurrently.

In FIG. 2, the total percentage or entire amount of incoming fluid fed onto a top screening deck is initially directed to top screen assembly 105, and is not diverted to other screen assemblies on other decks included in vibratory separator 102. In some embodiments, less than all of the incoming fluid may be distributed to the top screen assembly 105, and a remaining portion of any incoming fluid may be distributed to other screen assemblies included in vibratory separator 102.

In one or more embodiments, the solids separated by the first intermediate screen assembly 107 or the second intermediate screen assembly 109 may include lost circulation material, which is used to avoid the loss of drilling fluid into the earth formation during drilling operations. Lost circulation material (LCM) may be an expensive component of drilling fluid, and as such, the recovery of lost circulation material (LCM) may result in decreasing total drilling expenditures.

Screens may include what is known in the art as an API screen number, which is an industry standard which describes and defines the largest solid that may pass through a particular screen, (or the smallest solid captured on the surface or within the openings of a screen). The API screen number is one of the known identifiers used to select a screen suitable for a screening deck by those skilled in the art. In one or more embodiments, a screen suitable for a top screen assembly 105 may be range from API 10 to API 60 (e.g., API 20), and a screen suitable for the first and second intermediate screen assemblies 105 and 107 may range from API 80 to API 500 (e.g., API 100). Those of ordinary skill will appreciate that the present disclosure is not limited to the above described API screen numbers, and any range of API screen numbers may be used to operate vibratory separator 102. The API screen number is inversely related to the size of the holes in a mesh screen. For example, a mesh screen having a large API screen number may have a small mesh size (i.e., the size of the holes in the mesh screen), thereby filtering out solids having particulate sizes greater than the small mesh size. A mesh screen having a relatively smaller API screen number has a relatively larger mesh size, thereby filtering out solids having particulate sizes greater than the relatively larger mesh size.

Referring to FIG. 3, FIG. 3 is a diagram of a vibratory separator in combination series distribution mode according to embodiments described herein. The vibratory separator 102 includes four screening decks, i.e. 104, 106, 108, and 110. Also shown is direction of flow 204 of the incoming fluid, a discharge direction 206 of the solids separated from the incoming fluid due to the motion of the vibratory separator 102, and the direction of flow 308 of the exiting, i.e., outgoing, fluid after having passed through the screen assemblies included in FIG. 3.

Vibratory separator 102 in FIG. 3 is configured to operate in combination series distribution mode. Accordingly, a screen assembly 311 is provided on the bottom screening deck 110. The screen assembly 311 may be attached to the bottom screening deck 110 using a plurality of fasteners 111 on the bottom screening deck 110. The fasteners 111 may include clips, clamps, screws, or other fastening mechanisms known in the art. In some embodiments, fasteners 111 may include inserts or other interlocking shape that may extend from a screening deck into the screen assembly being attached thereto. In some embodiments, two or more fasteners 111 may be connected or in communication with a control to retract together at the same time. For example, two or more fasteners along a screening deck may be operatively connected to retract or to be moved (e.g., using a lever or control) at the same time to release or attach a screen assembly to the screening deck. Such configurations may be useful when removing or inserting a bottom screen assembly to a bottom screening deck to more quickly switch between combination series distribution flow and parallel distribution flow.

The operation of vibratory separator 102 in combination series distribution mode includes, directing an entire amount of incoming drilling fluid (flow 204) initially to the top screen assembly 105, after which the underflow is directed to the first and second intermediate screening decks via flow 212 and 214 in parallel where the underflow may be directed in substantially equal amounts to the first intermediate screening deck and the second intermediate screening deck). For example, first, underflow 302 from top screen assembly 105 passes in substantially equal amounts to first intermediate screen assembly 107 and second intermediate screen assembly 109; and then, the underflow 306 passes from the first intermediate screen assembly 107 and the second intermediate screen assembly 109 to the bottom screen assembly 311 disposed on bottom screening deck 110. In this manner, vibratory separator 102 is useful for operating in combination series fluid distribution mode.

In some embodiments, a vibratory separator configured in combination series distribution mode may include more than two intermediate screening decks (each intermediate screening deck having an intermediate screen assembly) between a top screening deck and a bottom screening deck, where underflow from the top screening deck may be directed to each of the intermediate screening decks concurrently (parallel flow), and then underflow from the lowermost intermediate screening deck may be directed to a bottom screen assembly assembled to the bottom screening deck (series flow). Further, in some embodiments, more than one bottom screening deck may be included in a vibratory separator operating in combination series distribution mode, where one or more of the bottom screening decks may have a bottom screen assembly assembled to the one or more bottom screening decks. Vibratory separator operating in combination series distribution mode and having more than one bottom screening deck may be configured to direct underflow from screening decks immediately above each bottom screening deck sequentially to each of the bottom screening decks. In other words, underflow from lowermost intermediate screening deck may be directed in series to each successive bottom screening deck having a bottom screen assembly assembled thereto.

A recovery trough for collecting the lost circulation material may be included in one or more embodiments, including being disposed at one or more locations adjacent to a side of the vibratory separator. For example, as shown in FIG. 3, a recovery trough 130 may be coupled to the first intermediate screening deck 106 and the second intermediate screening deck 108 at the discharge ends of the intermediate screening decks. According to embodiments of the present disclosure, recovery troughs may be coupled to one or more or each screening deck in a vibratory separator. Solid overflow from the first intermediate screening deck 106, which includes solids that are too large to fit through the perforations in the first intermediate screen assembly 107 on the first intermediate screening deck 106, may collect at the discharge end of the first intermediate screening deck 106 and flow into the recovery trough 130. Likewise, solid overflow from the second intermediate screening deck 108, which includes solids that are too large to fit through the perforations in the second intermediate screen assembly 109 on the second intermediate screening deck 108, may collect at the discharge end of the second intermediate screening deck 108 and flow into the recovery trough 132. The solid overflow may overflow from the first and second intermediate screening decks 106, 108 and collect into the recovery troughs 130, 132, along a bottom surface of the recovery troughs 130, 132. The bottom surface of the recovery troughs may be angled to direct the solid overflow into one or more containers, e.g., for purification, testing, discarding, or other purposes, or may be re-circulated into the drilling mud. In some embodiments, the solids that are collected in recovery troughs 130, 132 may include lost circulation material (LCM) such as wellbore strengthening materials (WSM). Examples of wellbore strengthening materials include sized-salts, sized-calcium carbonates, polymers, and other wellbore strengthening materials known in the art. Recovery troughs may be formed from various materials, such as steel, and may include various coatings to prevent corrosion during operation. Further, recovery trough(s) may be coupled to screening deck(s) using fasteners known in the art, such as bolts, or may have an interlocking geometry with the screening deck(s) for attachment thereto.

In the embodiment shown in FIG. 3, two recovery troughs 130, 132 are shown as being attached at the discharge end of each intermediate screening deck 106, 108. By using two recovery troughs 130, 132, the capacity of recovered materials/solids separated from the fluid 204 flowing through the vibratory separator 102 may be doubled. However, other configurations for attaching one or more recovery troughs at the discharge end of screening decks may be used. In some embodiments, a single recovery trough may span across two screening decks. For example, a single recovery trough may span across first and second intermediate screening decks to catch separated and discharged solids from the first and second intermediate screening decks. In some embodiments, a single recovery trough may be attached at the discharge end of a single screening deck, but may catch discharge from multiple screening decks. For example, a single recovery trough may be attached at a discharge end of a second intermediate screening deck, where the recovery trough may catch discharge from the second intermediate screening deck and a first intermediate screening deck positioned above the second intermediate screening deck. Recovery troughs may be used when vibratory separators are configured in a recovery mode, e.g., to recover types of solids separated from fluid, such as LCM and/or WSM. In some embodiments, vibratory separators may be configured in a non-recovery mode, where no recovery troughs are used with the vibratory separator.

In one or more embodiments, the screens selected for each screening deck, whether operating in parallel distribution mode as shown in FIG. 2 or in combination series distribution mode, as shown in FIG. 3, may be selected to be progressively smaller in mesh size, and thus screen out finer solids as any underflow progresses from the topmost screening deck to the bottom screening deck. In other words, a top screen assembly 105 may include a coarse screen for filtering out oversize material, first intermediate screen assembly 107 may include a medium mesh screen, second intermediate screen assembly 109 may include a medium or fine screen, and bottom screen assembly 311 (when used in combination series mode) may include a finer screen than the second intermediate screen assembly 109. The mesh sizes for the screens used in conjunction with screen assemblies shown in FIGS. 2 and 3 may be chosen for removing material of a certain dimension, including, but not limited to solids, debris, drilled cuttings, desirable additives, and or lost circulation material.

In one or more embodiments, vibratory separator 102 may be further useful in screening desirable additives, which includes well bore strengthening materials (WSM). As part of best drilling practices, a drilling fluid that is most suitable to the drilling conditions of a well bore is carefully selected, and certain additives to strengthen the well bore itself are provided. These additives are generally referred to as well bore strengthening materials (WSM). WSM may be specially formulated and sized particulate materials that are capable of entering a fracture that may have formed in the earth formation associated with a well bore and effectively arrest, or stop, its propagation by isolating the fracture from the rest of the well bore. Accordingly, the vibratory separator 102, in FIGS. 2 and 3, may be useful for recovering WSM by selecting one or more screen assemblies on any particular screening deck suitable for recovering the WSM included in the incoming (used) drilling fluid. The WSM may be recovered and transmitted for reuse or processing subsequent to its filtration by vibratory separator 102.

In one or more embodiments, vibratory separator 102 may include flow back pan 219, as shown in FIGS. 2 and 3, disposed beneath top screening deck 104. Further, in one or more embodiments, vibratory separator 102 may include flow back pans disposed beneath first intermediate screening deck 106, second intermediate screening deck 108, and even bottom screening deck 110 (optionally included therein). A flow back pan may allow for any underflow to “flow back” due to the titled angle of the flow back pan towards a feed end of vibratory separator 102 for further distribution to any one of the screening decks disposed below the flow back pan.

In one or more embodiments, a fluid distribution box 210 is included with a vibratory separator 102. Fluid distribution box 210 may be useful in directing any underflow transmitted to one or more screening decks in accordance with embodiments disclosed herein. A fluid distribution box 210 may be useful for distributing fluid throughout vibratory separator 102.

In one or more embodiments, fluid distribution box 210 may include a plurality of conduits for distributing fluid to one or more screening decks, which is further described in U.S. Patent Publication 2010/0237024, and incorporated herein by reference in its entirety. For example, flow back pan 219 (and any other included flow back pans disposed beneath any of the screening decks included with vibratory separator 102) may further be divided into a plurality of channels. Each channel of the flow-back pan 219 may correspond to one of the plurality of conduits in the fluid distribution box 210, and each channel may communicate a stream of the initially separated drilling fluid to the corresponding conduit. Further, each conduit of fluid distribution box 210 may route the underflow stream of top screening deck 104 to a corresponding conduit to access to a screen assembly disposed on the first intermediate screening deck 106, second intermediate screening deck 108, and/or bottom screening deck 110 to route underflow in accordance with parallel distribution mode or combination series distribution mode as disclosed herein.

The plurality of conduits in fluid distribution box 210 may be formed by horizontal and vertical partitions that selectively route underflow to the screening decks below the top screening deck 104. One or more removable panels (not shown) may also be included with vibratory separator 102 to direct and orient flow from one screening deck to another. Those of ordinary skill in the art will appreciate that the fluid distribution in vibratory separator 102 may be accomplished in several ways without departing from the scope of the present disclosure.

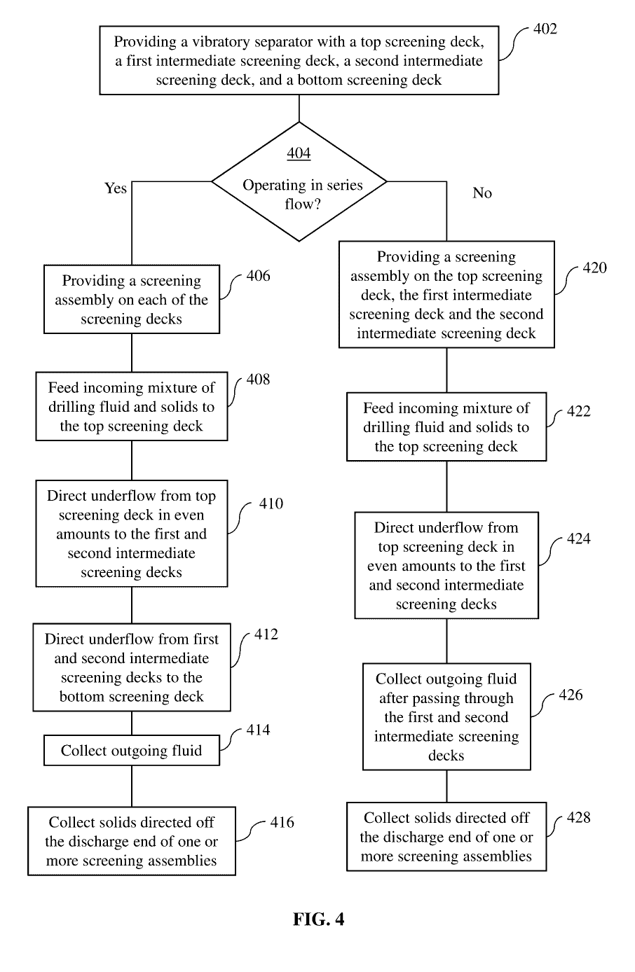

FIG. 4 is a flowchart of a process for separating solid material suspended in incoming fluid that is fed to a vibratory separator according to embodiments disclosed herein. It should be noted that one or more actions of the process disclosed herein may be performed before or after each other without departing from the scope of the present disclosure, as long as the actions are not mutually exclusive or contradictory.

In FIG. 4, a vibratory separator is provided with four levels, whereby the levels include four screening decks (402). A vibratory separator is included with a top screening deck, a first intermediate screening deck, a second intermediate screening deck, and a bottom screening deck. In one or more embodiments, the screening decks may include one or more flow back pans disposed beneath each screening deck. A determination is made whether to operate the vibratory separator in combination series flow or parallel flow (404). For example, in some embodiments, combination series flow may be selected for LCM/WSM recovery. In LCM/WSM recovery, the intermediate decks of the vibratory separator may be screened with the same API screens, where the solids recovered may be reused. In some embodiments, combination series flow may be selected to provide fine cut cleaning. For example, near completion of a well, one or more vibratory separators in combination series mode may be used to provide fine and exact cut point separation of solids from used drilling fluid, for cleaning the used drilling fluid prior to returning to the drilling system. In some embodiments, parallel flow may be selected, for example, during normal drilling operations or when separating relatively large volumes of fluid. In some embodiments, parallel flow may be selected when separating spud drilling mud. In some embodiments, parallel flow may be selected when separating sweep drilling fluid.

Upon determining to operate the vibratory separator in combination series flow, a screen assembly is disposed on each screening deck including the bottom screening deck (406). Incoming fluid that may be a mixture of used drilling fluid and solids contained in the drilling fluid may be fed to a top screening deck located on the vibratory separator (408). The top screening deck includes a top screen assembly. Any underflow from the top screening deck is directed in even amounts from the top screening deck to the first and second intermediate screening decks (410). Underflow from the first and second intermediate screening decks are directed to the bottom screening deck (412). Optionally, any outgoing fluid exiting from a bottom surface of vibratory separator 102 may be collected (414), and any solids discharged from vibratory separator (discharged at the discharge end of one or more screening decks of the vibratory separator) may be collected as well (416).

Upon determining to operate the vibratory separator in parallel flow (404), a screen assembly may be provided on each of the screening decks, except for the bottom screening deck (420). In some embodiments, a vibratory separator configured in combination series distribution mode, as disclosed herein, may be reconfigured to operate in parallel distribution mode by removing the screen assembly from the bottom screening deck. Incoming fluid that may be a mixture of used drilling fluid and solids contained in the drilling fluid may be fed to a top screening deck located on the vibratory separator (422). In one or more embodiments, underflow remaining after passing through a top screen assembly disposed on a top screening deck is directed in even or substantially even amounts to a first intermediate screening deck and also to a second intermediate screening deck (424). In one or more embodiments, the underflow when distributed in parallel distribution mode is distributed simultaneously or substantially simultaneously so as to allow for parallel screening at the same time. This may further allow for the outgoing fluid from the first and second intermediate screening decks to exit the vibratory separator at substantially the same time. Subsequently, any outgoing fluid may be collected (426) as well as any solids discharged during the parallel distribution screening process (428).

Embodiments disclosed herein may provide for a vibratory separator that generates dry cuttings, removes unwanted solid material, recovers valuable drilling fluid, as well as recovers desirable additives, such as lost circulation material and well bore strengthening materials. Additionally, the different embodiments described herein disclose a vibratory separator that may have a small footprint, i.e., takes up a reduced amount of valuable and limited space on an oil and gas drilling site, while offering capability to operate in either parallel or combination series fluid distribution mode in the same apparatus. Vibratory separators according to one or more embodiments disclosed herein may provide for an effective and simplified method to operate a vibratory separator in either parallel distribution flow or combination series distribution flow by either including or excluding a bottom screen assembly on a bottom screening deck. The addition of the fourth level, i.e., bottom screening deck, may further provide for greater non-blanked screening area, which refers to the available screening area. Greater non-blanked screening area means that the embodiments disclosed herein may be capable of handling a higher quantity of fluid due to the higher percentage of available screening area. Further, a vibratory separator in accordance with one or more embodiments described herein may increase production of filtered drilling fluid for recovery and reuse with less inclusion of undesirable cuttings or other debris from a previous drilling run.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. An apparatus comprising:
a top screening deck;
two intermediate screening decks comprising a first intermediate screening deck and a second intermediate screening deck; and
a bottom screening deck,
wherein the vibratory separator is adjustable to change a distribution of the incoming fluid between parallel distribution flow and combination series distribution flow,
wherein a bottom screen assembly is disposed on the bottom screening deck when the vibratory separator is configured in the combination series distribution flow, and wherein the bottom screen assembly is excluded from the bottom screening deck when the vibratory separator is configured in the parallel distribution flow.

2. The apparatus of claim 1, wherein a top screen assembly is disposed on a top screening deck, a first intermediate screen assembly is disposed on the first intermediate screening deck, and a second intermediate screen assembly is disposed on the second intermediate screening deck, wherein the vibratory separator is configured to distribute the incoming fluid from the top screening deck to the first and second intermediate screening decks in substantially even amounts at substantially the same time.

3. The apparatus of claim 1, wherein the vibratory separator includes at least a recovery trough configured to collect lost circulating material separated from the incoming fluid.

4. The apparatus of claim 1, further comprising a fluid distribution box.

5. The apparatus of claim 1, wherein the vibratory separator includes a discharge end, wherein the discharge end is configured to discharge the solid material away from the top screening deck, the two intermediate screening decks, and the bottom screening decks.

6. The apparatus of claim 1, wherein a flow back pan is positioned beneath at least one of the top screening deck, the first intermediate screening deck and the second intermediate screening deck.

7. The apparatus of claim 1, further comprising a plurality of fasteners on the bottom screening deck, where in combination series distribution flow, the bottom screen assembly is fastened to the bottom screening deck with the plurality of fasteners.

8. A method, comprising:
providing a vibratory separator at a drill site, the vibratory separator configured to operate in either a parallel distribution mode or a combination series distribution mode;
selecting the parallel distribution mode or the combination series distribution mode;
wherein upon selecting the parallel distribution mode, a bottom screen assembly is removed from a bottom screening deck in the vibratory separator; and
wherein upon selecting the combination series distribution mode, the bottom screen assembly is assembled to the bottom screening deck.

9. The method of claim 8, wherein the vibratory separator separates solids from a drilling mud that circulates through the drill site.

10. The method of claim 8, wherein the vibratory separator comprises:
a top screening deck comprising a top screen assembly;
a first intermediate screening deck comprising a first intermediate screen assembly; and
a second intermediate screening deck comprising a second intermediate screen assembly;
wherein drilling mud is directed from the top screening deck to the first and second intermediate screening decks in substantially even amounts at substantially the same time; and
wherein the drilling mud is directed from the second intermediate screening deck to the bottom screening deck.

11. A method comprising:
providing a vibratory separator configured to interchangeably operate in a parallel distribution mode and a combination series distribution mode, the vibratory separator including a top screening deck, a first intermediate screening deck, a second intermediate screening deck, and a bottom screening deck;
operating the vibratory separator in either the parallel distribution mode or the combination series distribution mode,
wherein operating the vibratory separator in parallel distribution mode comprises:
feeding solids laden fluid into a feed end of a vibratory separator;
directing the solids laden fluid to the top screening deck of the vibratory separator;
directing a substantially even amount of underflow from the top screening deck to the first intermediate screening deck and to the second intermediate screening deck at substantially the same time;
collecting outgoing fluid that has passed through the first and second intermediate screening decks; and
wherein operating the vibratory separator in the combination series distribution mode comprises:
feeding solids laden fluid into the feed end of the vibratory separator;
distributing the solids laden fluid to the top screening deck of the vibratory separator;
directing a substantially even amount of underflow from the top screening deck to the first intermediate screening deck and to the second intermediate screening deck at substantially the same time;
directing the underflow from the second intermediate screening deck to the bottom screening deck, wherein the bottom screening deck includes a bottom screen assembly disposed on the bottom screening deck; and
collecting outgoing fluid exiting from the bottom screen assembly.

12. The method of claim 11, wherein the method further comprises:
providing motion to the vibratory separator, wherein solids from the solid laden fluid move to a discharge end of the top screening deck responsive to the motion.

13. The method of claim 11, wherein the top screening deck has a top screen assembly with a first mesh size, the first intermediate screening deck has a first intermediate screen assembly with a second mesh size and the second intermediate screening deck has a second intermediate screen assembly with a third mesh size.

14. The method of claim 13, wherein the first mesh size is larger than the second and third mesh size, and the second and third mesh sizes are equal.

15. The method of claim 13, wherein the first mesh size is larger than the second mesh size, and the second mesh size is larger than the third mesh size.

16. The method of claim 13, wherein when operating the vibratory separator in the combination series distribution mode, a mesh size of the bottom screen assembly is smaller than the first, second and third mesh sizes.

17. The method of claim 11, wherein a flow back pan is positioned beneath the top screening deck.

18. The method of claim 11, further comprising, discarding the fluid in a recovery trough for collecting lost circulation material.

19. The method of claim 11, further comprising redirecting the outgoing fluid for additional processing and reuse.

20. The method of claim 11, further comprising, adjusting a screen tilt angle of any one of the plurality of screening decks, wherein the vibratory separator includes an angle adjustment mechanism.
